(19) United States
(12) Patent Application Publication
(10) Pub. No.: US 2026/0242302 A1
(43) Pub. Date: Aug. 20, 2026

(54) A COMPOUND MIXTURE

(71) Applicant: ANGLO AMERICAN WOODSMITH LIMITED, London (GB)

(72) Inventors: Jonathan Richard Walton BROWN, London (GB); Timothy David LEWIS, London (GB)

(21) Appl. No.: 18/872,361

(22) PCT Filed: Jun. 22, 2023
(86) PCT No.: PCT/IB2023/056459

§ 371 Date: Dec. 6, 2024

(30) Foreign Application Priority Data
Jun. 24, 2022 (GB) 2209277.9

(51) Int. Cl. C05D 1/02; C05G 3/50; C05G 3/60; C05G 5/27

(52) U.S. Cl. CPC C05D 1/02; C05G 3/50; C05G 3/60; C05G 5/27

(57) ABSTRACT

This invention relates to a polyhalite suspension and a process for the manufacture thereof. The polyhalite suspension may further comprise one or more dispersing agent/s, thickening agent/s, rheology modifier/s, preservative/s, antifoaming agent/s, wetting agent/s and anti-freeze agent/s in a liquid solvent, preferably water.

### INTRODUCTION

This invention relates to a polyhalite suspension and a process for the manufacture thereof. The polyhalite suspension may further comprise one or more dispersing agent/s, thickening agent/s, rheology modifier/s, preservative/s, antifoaming agent/s, wetting agent/s and anti-freeze agent/s in a liquid solvent, preferably water.

### BACKGROUND OF THE INVENTION

Polyhalite, K₂Ca₂Mg(SO₄)₄·2H₂O, is a mineral best known as a multi-nutrient fertilizer containing sulphate, potassium, magnesium and calcium. It is currently practically used in powder and granule form. Such a solid form of polyhalite has applications as a solid fertilizer amongst other uses in solid forms for specific applications. Problems may include the production of dust, difficulties, or inaccurate dosing where weighing is required, or handling problems in bulk as a solid material. Furthermore, polyhalite has limited solubility in water and, upon use with water, can cause obstruction or blockages in pipes without sufficient pressure to flush the system and at inappropriate particle sizes. Therefore, making polyhalite impractical to use within an irrigation/fertigation system in its native form.

A need exists for a polyhalite suspension that ameliorates the abovementioned problems for applications in liquid media.

### SUMMARY OF THE INVENTION

An embodiment of the invention provides for a polyhalite suspension comprising:
50 to 80% (w/w), preferably 55 to 75% (w/w) and more preferably 60 to 65% (w/w) polyhalite,
15 to 40% (w/w), preferably 15 to 35% (w/w) and more preferably 20 to 30% (w/w) liquid solvent/s, such as water; and
0.5 to 10% (w/w), preferably 1 to 8% (w/w) and even more preferably 2 to 5% (w/w) dispersing agent.

The suspension further comprises 0.1 to 12% (w/w), preferably 0.5 to 5% (w/w) and even more preferably 0.75 to 3% (w/w) viscosity modifier or thickening agent.

The suspension may further comprise one or more of rheology modifiers, preservatives, antifoaming agents, wetting agents and anti-freeze components.

The polyhalite typically has a particle size range of less than 150 microns, less than 100 microns, or less than 50 microns. Preferably, the polyhalite has a particle size distribution of 90% below 30 microns.

In another embodiment of the invention provides for a process for the preparation of a polyhalite suspension comprising mixing 50 to 80% (w/w), preferably 55 to 75% (w/w) and more preferably 60 to 65% (w/w) polyhalite with 15 to 40% (w/w), preferably 15 to 35% (w/w) and more preferably 20 to 30% (w/w) liquid solvent and 0.5 to 10% (w/w), preferably 1 to 8% (w/w) and even more preferably 2 to 5% (w/w) dispersing agent to produce a polyhalite suspension.

Polyhalite may be blended with solid minerals or inorganic salts before adding the liquid solvent/s and dispersing agent, to produce a mixed solid suspension. The solid minerals or inorganic salts may be present in an amount of 1 to 30% by weight of the solid and may be selected from inorganic oxides, carbonates, or sulphates, not limited to oxides and dioxides, carbonates or sulphates of chemically stable inorganic salts of Calcium, Magnesium, Zinc, Manganese, Titanium, Potassium, Copper and Iron, inorganic salts of organic acids such as ethylenediaminetetraacetic acid or other chelating agents or a combination thereof.

Typically, the components are mixed using a high shear mixing system.

The process may further comprise additional mixing of 0.1 to 12% (w/w), preferably 0.5 to 5% (w/w) and even more preferably 0.75 to 3% (w/w) viscosity modifier or thickening agent.

The process may further comprise mixing one or more of formulation enhancers, optionally rheology modifiers, preservatives, antifoaming agents, wetting agents and anti-freeze components.

In another embodiment of the invention provides for a process involving a solid premix comprising polyhalite, and a dispersing agent in a solid form suitable for mixing with a liquid solvent to produce a polyhalite suspension as described above.

In another embodiment of the invention provides for a polyhalite containing powder comprising polyhalite and a dispersing agent in solid form suitable for mixing with a liquid solvent to produce a polyhalite suspension as described above.

The premix or polyhalite containing powder may further include a viscosity modifier or thickening agent in solid form.

The premix or polyhalite containing powder may further include mixing one or more of formulation enhancers, optionally rheology modifiers, preservatives, antifoaming agents, wetting agents and anti-freeze components in solid form.

The premix or polyhalite containing powder may further include mixing one or more of other solid minerals or inorganic salts to produce a mixed solid suspension. The solid minerals or inorganic salts may be present in an amount of 1 to 30% by weight of the solids and may be selected from inorganic oxides, carbonates, or sulphates, not limited to oxides and dioxides, carbonates or sulphates of chemically stable inorganic salts of Calcium, Magnesium, Zinc, Manganese, Titanium, Potassium, Copper and Iron, inorganic salts of organic acids such as ethylenediaminetetraacetic acid or other chelating agents or a combination thereof.

The dispersing agent may be selected from lignosulfonates, phosphate esters, higher molecular weight polymers such as polyacrylate esters or polycarboxylate derived dispersing agents, or a combination thereof.

The viscosity modifier or thickening agent may be selected from naturally or synthetically derived gums, optionally Carrageenan, Xanthan, Gellan, Arabica, cellulose, clay-based modifiers optionally Attapulgites, Bentonites, montmorillonites, polymeric modifiers optionally pH or chemically activated crosslinking polymers, or a combination thereof.

Additionally, an activator compound may be added to improve the performance of certain modifiers where selected, which offers better control of formulation viscosity through pH adjustment or through interactions within the gel structure. The activator compound may be selected from the groups of pyrophosphates, such as sodium or potassium pyrophosphates or a combination thereof and may be present in an amount of 0.1 to 1% by weight.

The rheology modifier/s may be selected from minerals and synthetic forms optionally silicates, or aluminosilicates, including but not limited to magnesium silicate, magnesium aluminium silicate, calcium silicates or calcium aluminosilicates, kaolin or other clay-based minerals or polymeric materials including cationic, non-ionic and anionic swellable polymers or a combination thereof and may be present in an amount of from 0.5 to 5%, 0.75 to 3.5%, or 1 to 3%, by weight.

The preservative/s may be selected from the biocidal or bacteriostatic category of preservatives, solutions of biocides containing optionally isothiazolinones, or bacteriostatic compounds including but not limited to sodium, potassium salts of benzoates and propionates or a combination thereof and may be present in an amount of from 0.01 to 1%, preferably 0.05 to 0.5%, and even more preferably 0.1 to 0.2% by weight.

The antifoaming agent/s may be selected from silicone-based emulsions, non-silicone-based emulsions, stearates optionally cetostearyl alcohols or glycols or a combination thereof and may be present in an amount of from 0.01 to 0.5%, preferably 0.025 to 0.25% and even more preferably 0.05 to 0.20% by weight.

The wetting agent/s may be selected from the multiple categories of surfactants. Examples including alkyl and alkyl amido betaine, or fatty acid, methyl ester, or vegetable oil ethoxylates, cocamidopropyl betaine, anionic surfactants such as sodium dodecylbenzene sulfonate, cationic surfactants such as quaternary ammonium salts or a combination thereof and may be present in an amount of from 0.5 to 5%, preferably 1.0 to 3.0% and even more preferably 1.5 to 2.5% by weight.

The anti-freeze agent/s may be selected from freezing point depressants such as alcohols, polyols or sugar alcohols, including but not limited to monoethylene glycol, polyethylene glycol, propylene glycol, sorbitol, glycerol, and molasses or a combination thereof. Others may include salts and soluble materials to depress freezing point, including but not limited to urea, and alkali metal chlorides or a combination thereof. And may be present in an amount of from 0.5 to 15%, preferably 1 to 12% and even more preferably 5 to 10% by weight.

The pH of the polyhalite suspension ranges from 5 to 9, preferably 5.5 to 8.5, and more preferably 6 to 8.

The density of the polyhalite suspension ranges from 1.50 to 2.00 g/cm³, preferably 1.60 to 1.90 g/cm³ and more preferably 1.70 to 1.80 g/cm³.

The viscosity of the polyhalite suspension ranges from 3500 to 7500 Centipoise (3.5 to 7.5 Pa·s), preferably 4500 to 6500 Centipoise (4.5 to 6.5 Pa·s), and more preferably 5000 to 6000 Centipoise (5 to 6 Pa·s).

In another embodiment the invention provides for a polyhalite suspension comprising:
60.00% (w/w) polyhalite,
26.50% (w/w) water,
2.82% (w/w) sodium lignosulfonate powder,
1.10% (w/w) bentonite clay.
4.30% (w/w) polyethylene glycol,
5.00% (w/w) sorbitol,
0.18% (w/w) antifoaming agent, and
0.1% (w/w) biocide.

In another embodiment the invention provides for a polyhalite suspension comprising:
59.98% (w/w) polyhalite,
34.61% (w/w) water,
2% (w/w) potassium lignosulfonate powder,
1% (w/w) attapulgite clay,
1.7% (w/w) glycerol,
0.23% (w/w) antifoaming agent,
0.1% (w/w) tetrasodium pyrophosphate,
0.1% (w/w) disodium ethylenediaminetetraacetic acid (Sodium EDTA),
0.17% (w/w) xanthan gum, and
0.11% (w/w) biocide solution.

### DESCRIPTION OF PREFERRED EMBODIMENTS

According to the present invention, the term “stable” can be defined as a state in which the rate of settlement of particles in suspension, i.e. polyhalite in suspension, is decreased through formulation, according to the present invention, to reduce the natural phase separation, which leads to sedimentation of the solids occurring over a longer timescale than an unformulated dispersion of polyhalite in a liquid medium or solvent/s.

The present invention relates to a suspension of mineral polyhalite in a liquid media or solvents, such as water, vegetable oil, mineral oil, glycerol, any other solvent capable of dispersing polyhalite powder, or alcohol, that is specifically a high density, viscous liquid suspension, which is capable of being used in applications for commercial and industrial uses, and delivers a high dosage of the polyhalite in a fluidized form for a chosen application.

The present invention provides a flowable suspension type product of polyhalite, which refers to a liquid phase with a suspended solid medium (polyhalite) within it.

The suspended polyhalite of the present invention has various applications, including, but not limited to: aerial applications, such as in arboriculture by plane, helicopter, spot application via Unmanned Aerial Systems (UAS), etc.; a fire suppressant/retardant; as a drilling additive or as a proppant in hydrocarbon recovery due to the polyhalite density being greater than water and thixotropic nature of the suspended material; heat exchangers due to its high heat retention capacity; as a fluid media for soil remediation/recovery of contaminated land; a method for delivery of a soil amendment for displacement of potentially toxic elements and cations in the soil; as a potential granulation aid or coating agent in the process of producing a granular product; and use for transporting polyhalite in flooded systems like rice whereby nutrients are added to a deliberately flooded area, with the nutrients depositing on the soil when the water is drained away.

The nature of the suspended polyhalite allows its application to be applied using a variety of equipment and infrastructure, including, but not limited to, agriculture such as glasshouse irrigation systems, drip and pivot irrigation, boom sprayers, knap sack sprayers, and tractor mounted/self-propelled spraying equipment. The stable suspended polyhalite may be used in applications for which the use of solid granules are more challenging, for example, in orchards it is difficult to distribute the polyhalite granules in a ring around individual trees in a uniform manner, whereas a pipe comprising of aqueous polyhalite suspension can be fed to the tree root zone that is more precise and efficient in practice; the delivery of a high-density liquid that can use the physical properties of suspended solid (polyhalite) that is not classified under current Classification, Labelling and Packaging of substances and mixtures (CLP) guidance. The present invention provides for delivery of polyhalite in tandem with a liquid solvent e.g. water, vegetable oil, mineral oil, glycerol, any other solvent capable of partially dissolving polyhalite powder, or alcohol.

The polyhalite suspension of the present invention may be a stable suspension.

The present invention further comprises the addition of a suitable dispersing agent, which is important to enable the desired concentration of the active ingredient to be achieved. The dispersing agent is not Seaweed, Polynaphthalene sulfonate or alginic acid. Further, viscosity modifiers, or thickening agents may be added, which is important to prevent phase separation beginning immediately and being complete within a matter of hours.

The suspension concentrate of polyhalite further comprises the addition of one or more of rheology modifiers, preservatives, antifoaming agents, wetting agents and anti-freeze agents.

The dispersing agents, viscosity modifiers or thickening agents, rheology modifiers, preservatives, antifoaming agents, wetting agents, anti-freeze agents, water and polyhalite are mixed using a high shear propellor system to produce a suspended component of polyhalite in an aqueous media or solvent/s.

The present invention also relates to a process for the preparation of the polyhalite suspension described above.

In another embodiment of the invention provides for a polyhalite containing powder comprising a polyhalite powder and a dispersing agent. The polyhalite containing powder comprises one or more of formulation enhancers comprising rheology modifiers, preservatives, antifoaming agents, wetting agents and anti-freeze agents in solid form.

In another embodiment of the invention provides for a process of making a polyhalite suspension including the steps of adding a volume of liquid, such as water, vegetable oil, mineral oil, diluted or neat glycerol, any other solvent capable of partially dissolving polyhalite powder, or alcohol, to a polyhalite containing powder to produce a polyhalite suspension. Antifoaming agents, preservatives and/or anti-freeze agents may be further added.

In another embodiment of the invention provides for the use of the polyhalite suspension described herein to be applied to an area.

### Example 1

The below example has been formulated to be based on a 1000 g total of the composition.

Formulation 1

| | |
|---|---|
| 600.0 g | polyhalite |
| 265.0 g | water |
| 28.2 g | sodium lignosulfonate powder |
| 11.0 g | bentonite clay |
| 50.0 g | sorbitol |
| 43.0 g | polyethylene glycol |
| 1.8 g | antifoaming agent |
| 1.0 g | sodium propionate |

The total amount of the above composition combined is 1000 g.

The elemental composition of the above formulation (by % (w/w)) is 7.0% K, 2.7% Mg, 7.7% Ca, 11.4% S.

### Method—Example 1

600 g of polyhalite powder, 28.2 g sodium lignosulfonate, 1.0 g sodium propionate and 5.5 g bentonite clay were all weighed into a container and blended to a uniform powder using a conical lab mixer and sealed tumbler system at 15 rpm for 10 minutes.

A beaker and stirrer were weighed. 210 g water, 43 g polyethylene glycol and 50 g sorbitol were added into a beaker underneath an overhead stirrer fitted with a four blade propellor. 1.8 g antifoaming agent was further added. The stirrer was lowered into the mixture and switched on to a speed of 800 rpm. 5.5 g of bentonite clay was added to the mixture until it was dispersed. The stirrer speed was increased as necessary, up to 1500 rpm.

317.4 g of the polyhalite powder mixture was added to the liquid mixture in increments of 50 g and the shear was increased up to 2000 rpm as required. After all solids from the first addition were incorporated, 317.3 g of the polyhalite powder mixture was added and the shear was increased to 2500 rpm. Once all the powder was evenly dispersed in the suspension, the mix was left for 15 minutes.

Thereafter, the mixture was left to disperse fully for at least 30 minutes at a speed of up to 2500 rpm. The beaker with stirrer was weighed and corrected to 1000 g tare weight with water.

The pH of the above embodiment is in the range 8 to 9.

The density of the above embodiment is 1.71 g/cm³.

The viscosity of the above embodiment is in the range 5000 to 6000 CentiPoise (5 to 6 Pa·s) @ 10 rpm using a Brookfield LVD-1 viscometer, spindle S63.

### Example 2

The below example has been formulated to be based on a 1000 g total of the composition.

Formulation 2

| | |
|---|---|
| 599.8 g | Polyhalite |
| 346.1 g | Water |
| 20 g | Potassium Lignosulfonate powder |
| 10 g | Attapulgite clay |
| 17 g | Glycerol |
| 2.3 g | Antifoaming Agent |
| 1 g | Tetrasodium Pyrophosphate |
| 1 g | Disodium Ethylenediaminetetraacetic acid (Sodium EDTA) |
| 1.7 g | Xanthan Gum |
| 1.1 g | Biocide solution |

The total amount of the above composition is 1000 g.

The elemental composition of the above formulation (by % (w/w)) is 7.0% K, 2.7% Mg, 7.7% Ca, 11.4% S.

### Method—Example 2

599.8 g of polyhalite powder, 20 g potassium lignosulfonate were weighed into a container and blended to a uniform powder using a conical lab mixer and sealed tumbler system at 15 rpm for 10 minutes.

A beaker and stirrer were weighed. 300 g water, 17 g Glycerol were added into a beaker underneath an overhead stirrer fitted with a four blade propellor. 2.3 g antifoaming agent was further added. The stirrer was lowered into the mixture and switched on to a speed of 800 rpm. 1 g Tetrasodium Pyrophosphate and 1 g Sodium EDTA were added to the mixture until it was dissolved. 10 g of attapulgite clay and 1.7 g Xanthan gum were added and left to disperse fully into the mix and the viscosity of the liquid phase increased.

312.8 g of the polyhalite powder mixture was added to the liquid mixture in increments of 50 g and the stirrer speed increased up to 2000 rpm as required. After all solids from the first addition were incorporated, 312.8 g of the polyhalite powder mixture was added and the shear was increased to 2500 rpm. Once all the powder was evenly dispersed in the suspension, the mix was left stirring for 15 minutes.

Thereafter, the mixture was left to disperse fully for at least 30 minutes at a speed of up to 2500 rpm. The beaker with stirrer was weighed and corrected to 1000 g tare weight with water.

The pH of the above embodiment is in the range 7 to 8.

The density of the above embodiment is 1.71 g/cm³.

The viscosity of the above embodiment is in the range 7000 to 7900 CentiPoise (6 to 7.5 Pa·s) @ 10 rpm using a Brookfield LVD-1 viscometer, spindle S63.

The viscosity on standing overnight increases up to 10,000 cP @10 rpm by the same method above.

All ranges disclosed herein include both endpoints and all numbers between the endpoints.

1-35. (canceled)

36. A polyhalite suspension comprising:
50 to 80% (w/w) polyhalite,
15 to 40% (w/w) a liquid solvent, and
0.5 to 10% (w/w) dispersing agent.

37. The suspension as claimed in claim 36, further comprising 0.1 to 12% (w/w), 0.5 to 5% (w/w), or 0.75 to 3% (w/w) viscosity modifier or thickening agent.

38. The suspension as claimed in claim 36, further comprising one or more of formulation enhancers comprising rheology modifiers, preservatives, antifoaming agents, wetting agents and anti-freeze components.

39. The suspension as claimed in claim 36, wherein the polyhalite has a particle size of less than 150 microns, less than 100 microns or less than 50 microns.

40. The suspension as claimed in claim 36, wherein the liquid solvent is water.

41. The suspension as claimed in claim 36, wherein the dispersing agent is selected from lignosulfonates, phosphate esters, higher molecular weight polymers, polycarboxylate derived dispersing agents, or a combination thereof.

42. The suspension as claimed in claim 37, wherein the viscosity modifier or thickening agent is selected from naturally or synthetically derived gums, optionally Carrageenan, Xanthan, Gellan, or Arabica; cellulose, clay-based modifiers, optionally Attapulgites, Bentonites, or montmorillonites; or polymeric modifiers, optionally pH activated crosslinking polymers or a combination thereof.

43. The suspension as claimed in claim 38, wherein rheology modifier/s is present in an amount of from 0.5 to 5%, 0.75 to 3.5%, or 1 to 3% by weight and/or the rheology modifier/s is selected from minerals and synthetic forms, optionally silicates and aluminosilicates, including magnesium silicate, magnesium aluminium silicate, calcium silicates or calcium aluminosilicates; kaolin or other clay-based minerals; or polymeric materials including cationic, non-ionic or anionic swellable polymers or a combination thereof.

44. The suspension as claimed in claim 38, wherein the preservative/s is present in an amount of from 0.01 to 1.0%, 0.05 to 0.5%, or 0.1 to 0.2% by weight and/or the preservative/s is selected from biocidal or bacteriostatic category of preservatives; solutions of biocides containing optionally such as isothiazolinones, or bacteriostatic compounds; or sodium, potassium salts of benzoates or propionates or a combination thereof.

45. The suspension as claimed in claim 38, wherein the antifoaming agent/s is present in an amount of from 0.01 to 0.5%, 0.025 to 0.25%, or 0.05 to 0.20% by weight and/or the antifoaming agent/s is selected from silicone or non-silicone-based emulsions, stearates optionally cetostearyl alcohols or glycols or a combination thereof.

46. The suspension as claimed in claim 38, wherein the anti-freeze agent/s is present in an amount of from 0.5 to 15%, 1 to 12%, or 5 to 10% by weight and optionally wherein the anti-freeze agent/s is selected from freezing point depressants, optionally alcohols, polyols or sugar alcohols selected from monoethylene glycol, polyethylene glycol, propylene glycol, glycerol, sorbitol or molasses; or salts or soluble materials to depress freezing point, optionally urea, or alkali metal chlorides or a combination thereof.

47. The suspension as claimed in claim 38, wherein the wetting agent/s is present in an amount of from 0.5 to 5.0%, 1.0 to 3.0%, or 1.5 to 2.5% by weight and optionally, wherein the wetting agent/s is selected from alkyl or alkyl amido betaine; fatty acid, methyl ester, or vegetable oil ethoxylates; cocamidopropyl betaine; anionic surfactants, optionally sodium dodecylbenzene sulfonates; or cationic surfactants, optionally quaternary ammonium salts or a combination thereof.

48. The suspension as claimed in claim 36, including an activator compound present in an amount of from 0.1 to 1.0% by weight and optionally wherein the activator compound is selected from the groups of pyrophosphates, optionally sodium or potassium pyrophosphates or a combination thereof.

49. The suspension as claimed in claim 36, wherein the pH of the polyhalite suspension ranges from 5 to 9, 5.5 to 8.5, or 6 to 8.

50. The suspension as claimed in claim 36, wherein the density of the polyhalite suspension ranges from 1.50 to 2.00 g/cm³, 1.60 to 1.90 g/cm³, or 1.70 to 1.80 g/cm³ and/or the viscosity of the polyhalite suspension ranges from 3500 to 7500 Centipoise (3.5 to 7.5 Pa·s), 4500 to 6500 Centipoise (4.5 to 6.5 Pa·s), or 5000 to 6000 Centipoise (5 to 6 Pa·s).

51. The suspension as claimed in claim 36, wherein the polyhalite is blended with solid minerals or inorganic salts before adding the liquid solvent/s and dispersing agent, to produce a mixed solid suspension.

52. The suspension as claimed in claim 51, wherein the solid minerals or inorganic salts is present in an amount of 1 to 30% by weight of solid and/or are selected from inorganic oxides, carbonates, or sulphates, not limited to oxides and dioxides, carbonates or sulphates of chemically stable inorganic salts of Calcium, Magnesium, Zinc, Manganese, Titanium, Potassium, Copper and Iron, inorganic salts of organic acids or other chelating agents or a combination thereof.

53. A polyhalite containing powder comprising polyhalite and a dispersing agent in solid form suitable for mixing with a liquid solvent to produce a polyhalite suspension comprising:
50 to 80% (w/w) polyhalite,
15 to 40% (w/w) a liquid solvent, and
0.5 to 10% (w/w) dispersing agent.

54. The polyhalite containing powder as claimed in claim 53, further including a viscosity modifier or thickening agent in solid form and optionally one or more of rheology modifiers, preservatives, antifoaming agents, wetting agents, anti-freeze, and activator components in solid form.

55. Process for soil remediation and/or recovery of contaminated land wherein the process comprises applying the polyhalite suspension as claimed in claim 36, or the polyhalite containing powder as claimed in claim 53, to the contaminated land.
